(19) United States
(12) Patent Application Publication
(10) Pub. No.: US 2017/0094190 A1
(43) Pub. Date: Mar. 30, 2017

(54) PROCESSING DISPLAY OF DIGITAL CAMERA READOUT WITH MINIMAL LATENCY

(71) Applicant: Microsoft Technology Licensing, LLC, Redmond, WA (US)

(72) Inventor: Klaus Melakari, Oulu (FI)

(21) Appl. No.: 14/871,729

(22) Filed: Sep. 30, 2015

(51) Int. Cl. H04N 5/265; H04N 5/378; H04N 5/232

(52) U.S. Cl. CPC H04N 5/265; H04N 5/23293; H04N 5/378; H04N 5/3532

(57) ABSTRACT

In one example, a device comprises a first interface configured to receive an image frame one fraction at a time, the image frame having been captured with a memoryless digital image capture unit. The device further comprises a processing unit configured to process the received fractions of the image frame. The device further comprises a second interface configured to output the processed fractions of the image frame to a memoryless display one fraction at a time.

### BACKGROUND

Processing images captured with a digital camera before they are displayed, for example by adding augmented reality content or otherwise enhancing them, is becoming common. As a result, there may be instances when low enough latency is not achieved between camera readout and display refresh to allow a comfortable viewing experience.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one example, a device comprises a first interface configured to receive an image frame one fraction at a time, the image frame having been captured with a memoryless digital image capture unit; a processing unit configured to process the received fractions of the image frame; and a second interface configured to output the processed fractions of the image frame to a memoryless display one fraction at a time.

In another example, another device and a system have been discussed along with the features of the device.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is an example block diagram of a device in accordance with an example embodiment;

FIG. 2 is an example block diagram of a device in accordance with an example embodiment;

FIG. 3 is an example block diagram of a system in accordance with an example embodiment;

FIG. 4 is an example diagram illustrating synchronization between digital image capture unit readout and display refresh in accordance with an example embodiment;

FIG. 5 illustrates an example block diagram of an apparatus capable of implementing example embodiments described herein; and

FIG. 6 illustrates an example block diagram of an apparatus capable of implementing example embodiments described herein.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

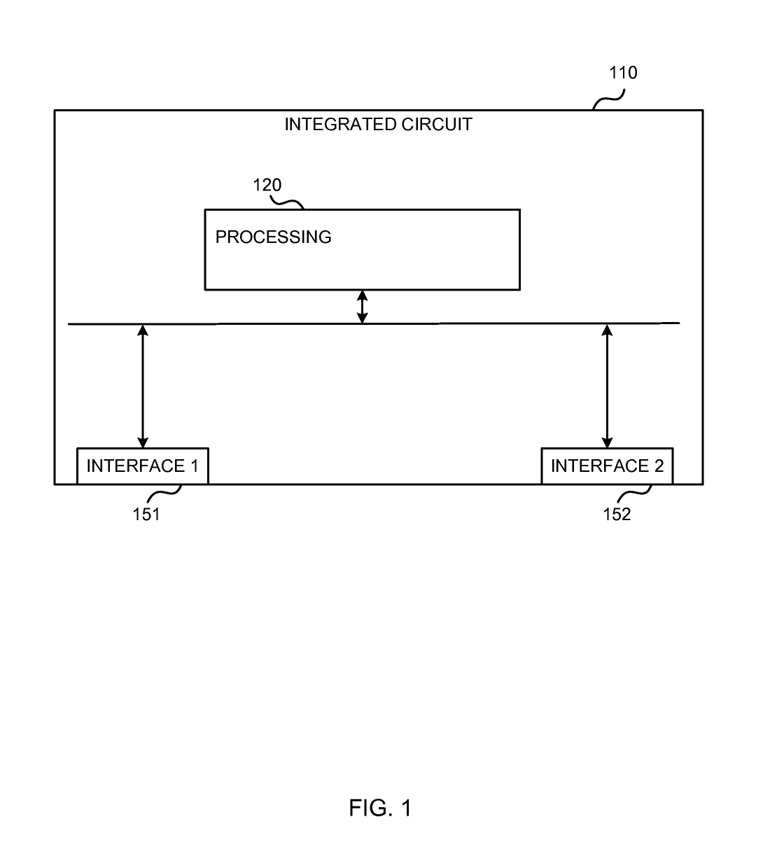

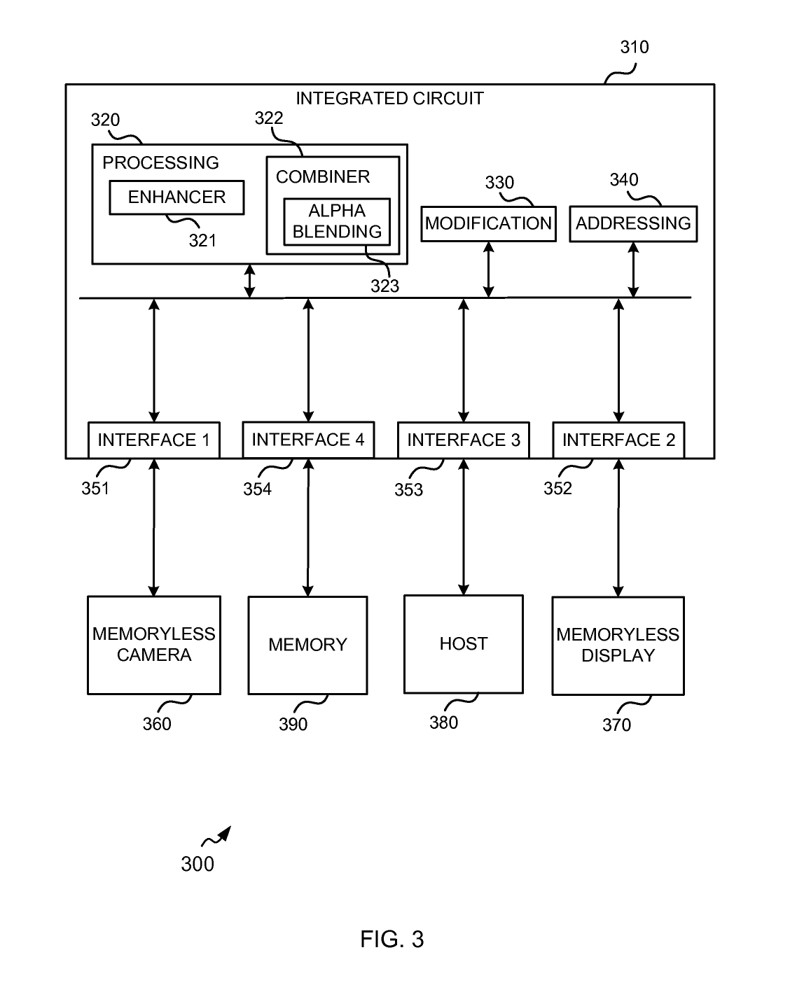

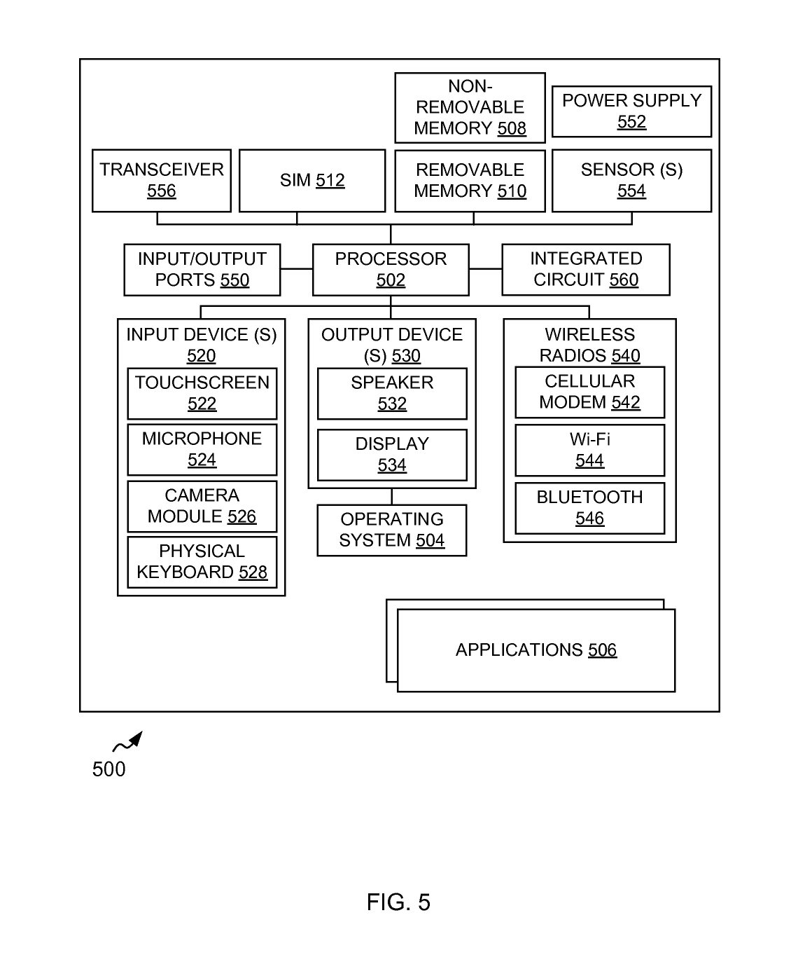

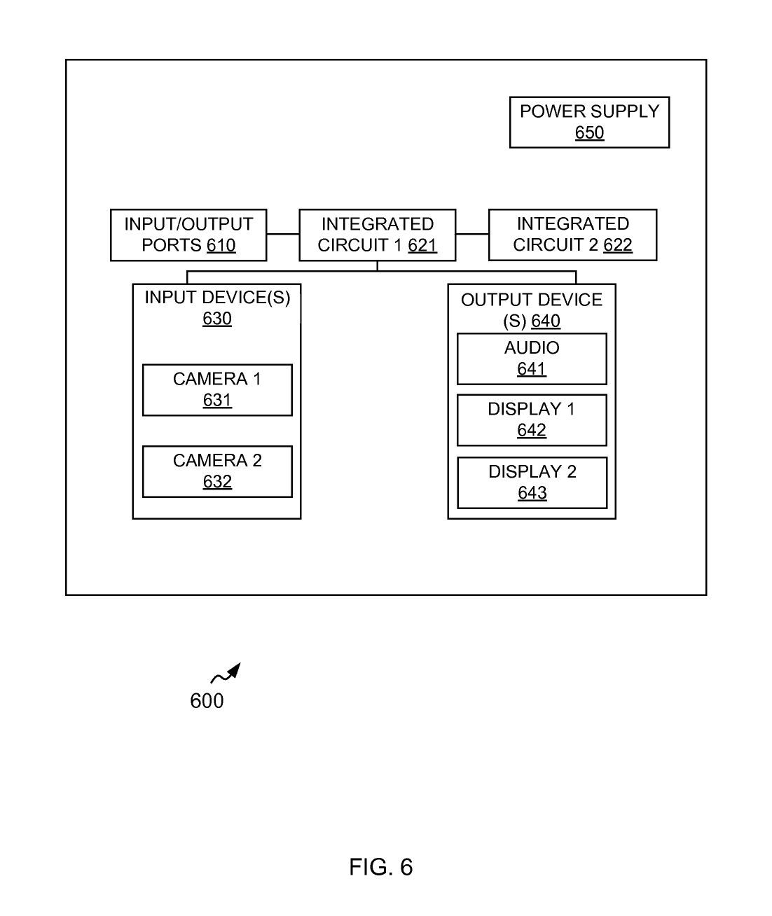

FIG. 1 illustrates a device 110 in accordance with an example embodiment. The device 110 may be employed, for example, in the system 300 of FIG. 3 or the apparatus 500 of FIG. 5 or the apparatus 600 of FIG. 6. However, it should be noted that the device 110 may also be employed on a variety of other apparatuses, and therefore, embodiments should not be limited to application on apparatuses such as the system 300 of FIG. 3, the apparatus 500 of FIG. 5 and the apparatus 600 of FIG. 6. Furthermore, it should be noted that at least some of the elements described below may not be mandatory and thus some may be omitted in certain embodiments.

The device 110 comprises a first interface 151 that is configured to receive an image frame one fraction at a time. The image frame has been captured with a memoryless digital image capture unit. The received image frame may be an image frame of a video stream that is being captured with the memoryless digital image capture unit. The video stream may comprise live footage or content seen by the memoryless digital image capture unit. In an embodiment, at least one of the fractions of the image frame may consist of one pixel. In an embodiment, each fraction of the image frame may consist of one pixel. In an embodiment, at least one of the fractions of the image frame may consist of e.g. no more than one tenth of the pixels of the image frame. The first interface 151 may be any suitable digital camera interface, such as a MIPI (Mobile Industry Processor Interface) Alliance CSI (Camera Serial Interface).

The device 110 further comprises a processing unit 120 that is configured to process the received fractions of the image frame. The device 110 further comprises a second interface 152 that is configured to output the processed fractions of the image frame to a memoryless display one fraction at a time. The second interface 152 may be any suitable digital display interface, such as a MIPI (Mobile Industry Processor Interface) Alliance DSI (Display Serial Interface). The second interface 152 may be synchronized with the first interface 151 so that readout of the digital image capture unit is synchronized with refresh of the display. The device 110 may be comprised in or implemented as an integrated circuit. The integrated circuit may be a customizable integrated circuit, such as a field-programmable gate array (FPGA).

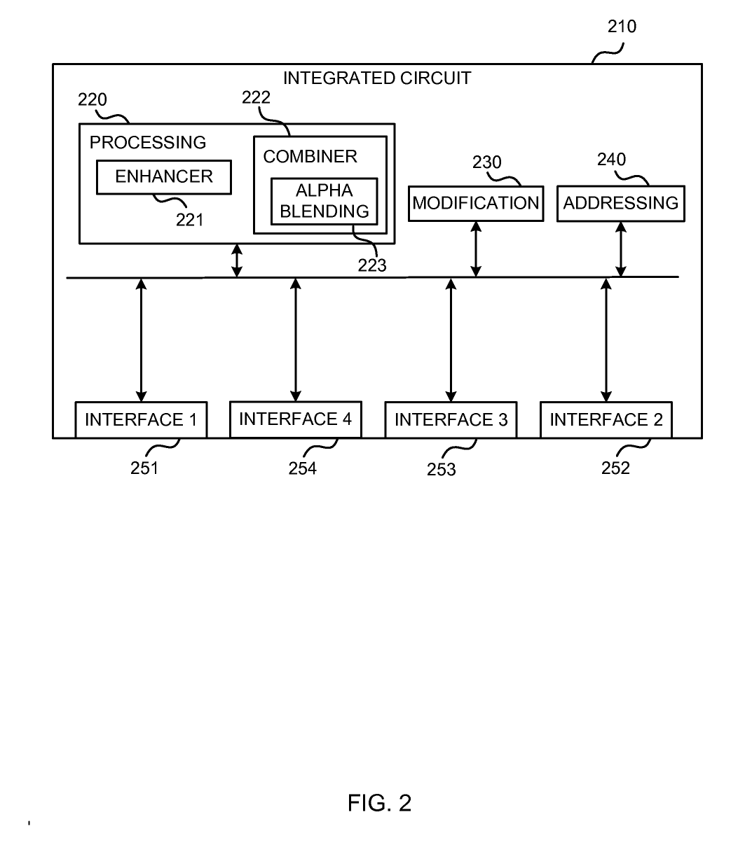

FIG. 2 illustrates a device 210 in accordance with an example embodiment. The device 210 may be employed, for example, in the system 300 of FIG. 3 or the apparatus 500 of FIG. 5 or the apparatus 600 of FIG. 6. However, it should be noted that the device 210 may also be employed on a variety of other apparatuses, and therefore, embodiments should not be limited to application on apparatuses such as the system 300 of FIG. 3, the apparatus 500 of FIG. 5 and the apparatus 600 of FIG. 6. Furthermore, it should be noted that at least some of the elements described below may not be mandatory and thus some may be omitted in certain embodiments.

The device 210 comprises a first interface 251 that is configured to receive an image frame one fraction at a time. The image frame has been captured with a memoryless digital image capture unit. The received image frame may be an image frame of a video stream that is being captured with the memoryless digital image capture unit. The video stream may comprise live footage or content seen by the memoryless digital image capture unit. Each fraction of the image frame may consist of e.g. one pixel. Alternatively, each fraction of the image frame may consist of e.g. no more than one tenth of the pixels of the image frame. The first interface 251 may be any suitable digital camera interface, such as a MIPI (Mobile Industry Processor Interface) Alliance CSI (Camera Serial Interface).

The device 210 further comprises a processing unit 220 that is configured to process the received fractions of the image frame. The processing unit 220 may comprise an enhancement unit 221 that is configured to enhance the received fractions of the image frame. The enhancement performed by the enhancement unit 221 may comprise e.g. vision related enhancement(s), such as enhancement(s) based on infrared, ultraviolet or any other invisible to human eye frequencies, for example to allow better low light visibility and/or thermal vision.

The device 210 may further comprise a third interface 253 that is configured to receive overlay data associated with at least one of the received fractions of the image frame. The received overlay data may comprise synthetic and/or virtual and/or computer-generated and/or augmented reality related imagery. The processing unit 220 may further comprise a combiner 222 that is configured to mix the received overlay data with its associated at least one received fraction of the image frame. The combiner 222 may comprise an alpha blending unit 223 that is configured to perform the mixing of the received overlay data with its associated at least one received fraction of the image frame by alpha blending the received overlay data with its associated at least one received fraction of the image frame.

It is to be understood that at least one of the enhancement unit 221 and the combiner 222 may be omitted.

The device 210 further comprises a second interface 252 that is configured to output the processed fractions of the image frame to a memoryless display one fraction at a time. The second interface 252 may be any suitable digital display interface, such as a MIPI (Mobile Industry Processor Interface) Alliance DSI (Display Serial Interface). The second interface 252 may be synchronized with the first interface 251 so that readout of the digital image capture unit is synchronized with refresh of the display. The device 210 may be comprised in or implemented as an integrated circuit. The integrated circuit may be a customizable integrated circuit, such as a field-programmable gate array (FPGA).

The device 210 may further comprise a modification unit 230 that is configured to perform at least one of scaling and geometry correction on the received the image frame fractions before output to the memoryless display. If the device 210 is integrated in an eyeglasses type apparatus, such as the apparatus 600 of FIG. 6, and if the lenses that convert display image suitable to human eye cannot fully remove distortion, digital distortion correction or geometry correction may be needed. Distortion correction may require a small buffer between camera read-out and display write. Depending on the geometry correction, the needed buffer may be e.g. between 0%-25% of the image frame size.

The device 210 may further comprise an addressing unit 240 that is configured to control addressing between the received image frame fractions and the output image frame fractions. If the resolution of the digital image capture unit and the resolution of the display are the same, each pixel address in the digital image capture unit may be the same each pixel address written to the display. If the resolution of the digital image capture unit is larger than the resolution of the display, the pixel addresses written to the display may be smaller than pixel addresses in the digital image capture unit in which case the addressing unit 240 may be used to control the addressing.

The device 210 may further comprise a fourth interface 254 that is configured to receive buffered overlay data from a memory configured to buffer the overlay data received from the third interface 253. The overlay data received at the third interface 253 may be first transferred to the memory for buffering, and then, e.g. at predetermined intervals, buffered overlay data is received from the memory at the fourth interface 254.

FIG. 3 is an example block diagram of a system 300 in accordance with an example embodiment. The system 300 of FIG. 3 may be employed, for example, in the apparatus 500 of FIG. 5 or the apparatus 600 of FIG. 6. However, it should be noted that the system 300 of FIG. 3 may also be employed on a variety of other apparatuses, and therefore, embodiments should not be limited to application on apparatuses such as the apparatus 500 of FIG. 5 and the apparatus 600 of FIG. 6. Furthermore, it should be noted that at least some of the elements described below may not be mandatory and thus some may be omitted in certain embodiments.

In the example of FIG. 3, the functionalities of the device 310, the processing unit 320, the enhancement unit 321, the combiner 322, the alpha blending unit 323, the modification unit 330, the addressing unit 340, the first interface 351, the second interface 352, the third interface 353, and the fourth interface 354 are substantially similar to those of their counterparts in the examples of FIG. 1 and FIG. 2, so their descriptions are not repeated here in detail. The example of FIG. 3 further comprises a memoryless digital image capture unit 360, a memoryless display 370, a host 380, and a memory 390. The device 310, the memoryless digital image capture unit 360, the memoryless display 370, the host 380, and the memory 390 may all be employed in a single physical entity or one or more of them may be distributed in another physical entity. There may be e.g. two instances of the memoryless display 370, the memoryless digital image capture unit 360, and/or the device 310 even though only one of each is depicted in FIG. 3 for clarity. The memoryless digital image capture unit 360 may comprise a memoryless rolling shutter camera.

The host 380 may be any entity configured to provide the overlay data to the third interface 353. The memory 390 may be any memory configured to buffer the overlay data. The memory 390 may be configured to buffer the overlay data for at least one image frame. In the case of Full HD resolution of 1920×1080 pixels, the memory 390 may be 8 MB. In the case of Ultra HD (4K) resolution of 3840×2160 pixels, the memory 390 may be 32 MB. The memory 390 may comprise e.g. a dynamic random-access memory (DRAM).

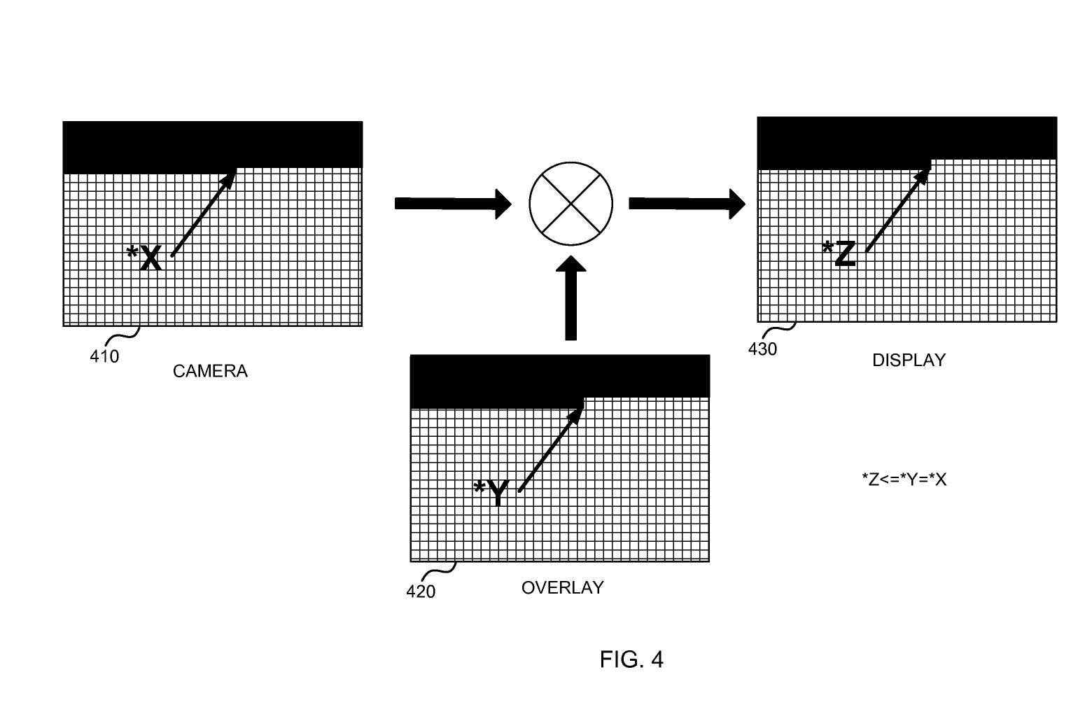

FIG. 4 is an example diagram illustrating synchronization between digital image capture unit readout and display refresh in accordance with an example embodiment. Element 410 represent pixels being read out from the memoryless digital image capture unit or camera. The black portion represents pixels that have already been read out. *X represents the pixel address of the camera pixel being currently read. Element 420 represent pixels being read from the overlay data. The black portion represents pixels that have already been read. *Y represents the pixel address of the overlay data pixel being currently read. Element 430 represent pixels being written to the memoryless display. The black portion represents pixels that have already been written. *Z represents the pixel address of the display pixel being currently written. Accordingly, as shown in FIG. 4, the pixel address of the display pixel being currently written is smaller than or equal to both the pixel address of the camera pixel being currently read and the pixel address of the overlay data pixel being currently read, depending on the respective resolutions of the camera and the display. The pixel address of the camera pixel being currently read is equal to the pixel address of the overlay data pixel being currently read.

FIG. 5 is a schematic block diagram of an apparatus 500 capable of implementing embodiments of the techniques described herein. It should be understood that the apparatus 500 as illustrated and hereinafter described is merely illustrative of one type of apparatus or an electronic device and should not be taken to limit the scope of the embodiments. As such, it should be appreciated that at least some of the components described below in connection with the apparatus 500 may be optional and thus in an example embodiment may include more, less or different components than those described in connection with the example embodiment of FIG. 5. As such, among other examples, the apparatus 500 could be any of wireless or mobile communication apparatuses, for example smartphones or tablet computers.

The illustrated apparatus 500 includes a controller or a processor 502 (i.e.—a signal processor, microprocessor, ASIC, or other control and processing logic circuitry) for performing such tasks as signal coding, data processing, input/output processing, power control, and/or other functions. An operating system 504 controls the allocation and usage of the components of the apparatus 500 and support for one or more application programs 506. The application programs 506 can include common mobile applications, for instance, telephony applications, email applications, calendars, contact managers, web browsers, messaging applications, or any other application.

The illustrated apparatus 500 includes one or more memory components, for example, a non-removable memory 508 and/or removable memory 510. The non-removable memory 508 can include RAM, ROM, flash memory, a hard disk, or other well-known memory storage technologies. The removable memory 510 can include flash memory or smart cards. The one or more memory components can be used for storing data and/or code for running the operating system 504 and the applications 506. The one or more memory components can be used for the memory 390 of FIG. 3. Example of data can include web pages, text, images, sound files, image data, video data, or other data sets to be sent to and/or received from one or more network servers or other devices via one or more wired or wireless networks. The electronic device 500 may further include a subscriber identity module (SIM) 512. The SIM 512 typically stores information elements related to a mobile subscriber. A SIM is well known in Global System for Mobile Communications (GSM) communication systems, Code Division Multiple Access (CDMA) systems, or with third-generation (3G) wireless communication protocols such as Universal Mobile Telecommunications System (UMTS), CDMA1000, wideband CDMA (WCDMA) and time division-synchronous CDMA (TD-SCDMA), or with fourth-generation (4G) wireless communication protocols such as LTE (Long-Term Evolution).

The apparatus 500 can support one or more input devices 520 and one or more output devices 530. Examples of the input devices 520 may include, but are not limited to, a touchscreen 522 (i.e., capable of capturing finger tap inputs, finger gesture inputs, multi-finger tap inputs, multi-finger gesture inputs, or keystroke inputs from a virtual keyboard or keypad), a microphone 524 (i.e., capable of capturing voice input), a camera module 526 (i.e., capable of capturing still picture images and/or video images) and a physical keyboard 528. Examples of the output devices 530 may include, but are not limited to a speaker 532 and a display 534. Other possible output devices (not shown) can include piezoelectric or other haptic output devices. Some devices can serve more than one input/output function. For example, the touchscreen 522 and the display 534 can be combined into a single input/output device. The display 534 may be used for the display 370 of FIG. 3. The camera module 526 may be used for the digital image capture unit 360 of FIG. 3.

In an embodiment, the apparatus 500 may comprise a wireless radio(s) 540. The wireless radio(s) 540 can support two-way communications between the processor 502 and external devices, as is well understood in the art. The wireless radio(s) 540 are shown generically and can include, for example, a cellular modem 542 for communicating at long range with the mobile communication network, a Wi-Fi radio 544 for communicating at short range with a local wireless data network or router, and/or a Bluetooth radio 546. The cellular modem 542 is typically configured for communication with one or more cellular networks, such as a GSM/3G network for data and voice communications within a single cellular network, between cellular networks, or between the mobile device and a public switched telephone network (PSTN).

The apparatus 500 can further include one or more input/output ports 550, a power supply 552, one or more sensors 554 for example, an accelerometer, a gyroscope, a compass, or an infrared proximity sensor for detecting the orientation or motion of the electronic device 500, a transceiver 556 (for wirelessly transmitting analog or digital signals) and an integrated circuit 560 that may be used for the device 110 of FIG. 1, the device 210 of FIG. 2, and/or the device 310 of FIG. 3. The illustrated components are not required or all-inclusive, as any of the components shown can be deleted and other components can be added.

FIG. 6 is a schematic block diagram of an apparatus 600 capable of implementing embodiments of the techniques described herein. It should be understood that the apparatus 600 as illustrated and hereinafter described is merely illustrative of one type of apparatus or an electronic device and should not be taken to limit the scope of the embodiments. As such, it should be appreciated that at least some of the components described below in connection with the apparatus 600 may be optional and thus in an example embodiment may include more, less or different components than those described in connection with the example embodiment of FIG. 6. As such, among other examples, the apparatus 600 could be any of eyeglass type or head-worn display type apparatuses, for example an eyeglass type apparatus or a head-worn display type apparatus suitable for augmented reality applications.

The illustrated apparatus 600 includes one or more input devices 630 and one or more output devices 640. Examples of the input devices 630 may include, but are not limited to, camera modules 631 and 632 (i.e., capable of capturing still picture images and/or video images). Examples of the output devices 640 may include, but are not limited to an audio output device 641 (e.g. speaker(s) and/or headphone(s)) and a display 642 for the left eye and a display 643 for the right eye. The displays 642, 643 may be used for the display 370 of FIG. 3. The camera modules 631, 632 may be used for the digital image capture unit 360 of FIG. 3.

The apparatus 600 can further include one or more input/output ports 610, a power supply 650, and integrated circuits 621, 622 that may be used for the device 110 of FIG. 1, the device 210 of FIG. 2, and/or the device 310 of FIG. 3. The illustrated components are not required or all-inclusive, as any of the components shown can be deleted and other components can be added.

Computer executable instructions may be provided using any computer-readable media that is accessible by computing based devices. Computer-readable media may include, for example, computer storage media such as memory and communications media. Computer storage media, such as memory includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media is shown within the computing based devices it will be appreciated that the storage may be distributed or located remotely and accessed via a network or other communication link, for example by using a communication interface.

At least some of the examples disclosed in FIGS. 1-6 are able to provide minimal latency between camera readout and display refresh due to not having to buffer complete image frames in the camera and the display, thus allowing a comfortable viewing experience. At least some of the examples disclosed in FIGS. 1-6 are able to provide latency between camera readout and display refresh that is no higher than a few milliseconds.

At least some of the examples disclosed in FIGS. 1-6 are able to provide low processing power requirements, for example due to not needing predictive computations. Accordingly, at least some of the examples disclosed in FIGS. 1-6 are able to provide high energy efficiency and low complexity.

At least some of the examples disclosed in FIGS. 1-6 are able to provide better black levels for augmented reality content than those of optical see-through type augmented reality eyeglasses or head-worn displays which, typically, can only add light, i.e. the best black level is determined by ambient light.

An embodiment of a device comprises a first interface configured to receive an image frame one fraction at a time, the image frame having been captured with a memoryless digital image capture unit; a processing unit configured to process the received fractions of the image frame; and a second interface configured to output the processed fractions of the image frame to a memoryless display one fraction at a time.

In an embodiment, alternatively or in addition to the above described embodiments, the processing unit comprises an enhancement unit configured to enhance the received fractions of the image frame.

In an embodiment, alternatively or in addition to the above described embodiments, the device further comprises a third interface configured to receive overlay data associated with at least one of the received fractions of the image frame, and the processing unit comprises a combiner configured to mix the received overlay data with its associated at least one received fraction of the image frame.

In an embodiment, alternatively or in addition to the above described embodiments, the combiner comprises an alpha blending unit configured to perform the mixing of the received overlay data with its associated at least one received fraction of the image frame by alpha blending the received overlay data with its associated at least one received fraction of the image frame.

In an embodiment, alternatively or in addition to the above described embodiments, the received overlay data comprises synthetic imagery.

In an embodiment, alternatively or in addition to the above described embodiments, the received image frame is an image frame of a video stream captured with the memoryless digital image capture unit.

In an embodiment, alternatively or in addition to the above described embodiments, at least one of the fractions of the image frame consists of one pixel.

In an embodiment, alternatively or in addition to the above described embodiments, the second interface is synchronized with the first interface.

In an embodiment, alternatively or in addition to the above described embodiments, the device further comprises a modification unit configured to perform at least one of scaling and geometry correction on the received the image frame fractions before output to the memoryless display.

In an embodiment, alternatively or in addition to the above described embodiments, the device further comprises an addressing unit configured to control addressing between the received image frame fractions and the output image frame fractions.

In an embodiment, alternatively or in addition to the above described embodiments, the device further comprises a fourth interface configured to receive buffered overlay data from a memory configured to buffer the overlay data received from the third interface.

In an embodiment, alternatively or in addition to the above described embodiments, the device is comprised in an integrated circuit.

An embodiment of a system comprises a memoryless digital image capture unit having a frame readout rate; a memoryless display having a refresh rate equal to the frame readout rate; and a device. The device comprises a first interface configured to receive an image frame one fraction at a time, the image frame having been captured with the memoryless digital image capture unit; a processing unit configured to process the received fractions of the image frame; and a second interface configured to output the processed fractions of the image frame to the memoryless display one fraction at a time.

In an embodiment, alternatively or in addition to the above described embodiments, the memoryless digital image capture unit comprises a memoryless rolling shutter camera.

In an embodiment, alternatively or in addition to the above described embodiments, the processing unit comprises an enhancement unit configured to enhance the received fractions of the image frame.

In an embodiment, alternatively or in addition to the above described embodiments, the device further comprises a third interface configured to receive overlay data associated with at least one of the received fractions of the image frame, and the processing unit comprises a combiner configured to mix the received overlay data with its associated at least one received fraction of the image frame.

In an embodiment, alternatively or in addition to the above described embodiments, the combiner comprises an alpha blending unit configured to perform the mixing of the received overlay data with its associated at least one received fraction of the image frame by alpha blending the received overlay data with its associated at least one received fraction of the image frame.

In an embodiment, alternatively or in addition to the above described embodiments, at least one of the fractions of the image frame consists of one pixel.

In an embodiment, alternatively or in addition to the above described embodiments, digital image capture unit readout is synchronized with display refresh.

An embodiment of a device comprises a first interface configured to receive an image frame one fraction at a time, the image frame having been captured with a memoryless digital image capture unit; a third interface configured to receive overlay data associated with at least one of the received fractions of the image frame; a combiner configured to mix the received overlay data with its associated at least one received fraction of the image frame; and a second interface configured to output each received fraction of the image frame to a memoryless display one fraction at a time, the output image frame fractions mixed with the associated overlay data as needed.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include mobile telephones (including smart phones), tablet computers and many other devices.

The processes described herein may be performed by software in machine readable form on a tangible storage medium e.g. in the form of a computer program comprising computer program code means adapted to perform all the steps of any of the processes described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims, and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

Aspects of any of the examples described above may be combined with aspects of any of the other examples described to form further examples without losing the effect sought.

The term ‘comprising’ is used herein to mean including the blocks or elements identified, but that such blocks or elements do not comprise an exclusive list, and a system, a device or an apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification. In particular, the individual features, elements, or parts described in the context of one example, may be connected in any combination to any other example also.

1. A device, comprising:
a memory; and
one or more processors programmed to:
receive an image frame one fraction at a time, the image frame having been captured with a memoryless digital image capture unit;
buffer each of the received fractions of the image frame; and
output each of the buffered fractions of the image frame to a memoryless display one at a time.

2. The device as claimed in claim 1, wherein the one or more processors are further programmed to enhance the received fractions of the image frame.

3. The device as claimed in claim 1, wherein the one or more processors are further programmed to:
receive overlay data associated with at least one of the received fractions of the image frame; and
mix the received overlay data with its associated at least one received fraction of the image frame.

4. The device as claimed in claim 3, wherein the one or more processors are further programmed to perform the mixing of the received overlay data with its associated at least one received fraction of the image frame by alpha blending the received overlay data with its associated at least one received fraction of the image frame.

5. The device as claimed in claim 3, wherein the received overlay data comprises synthetic imagery.

6. The device as claimed in claim 1, wherein the received image frame is an image frame of a video stream captured with a memoryless digital image capture unit.

7. The device as claimed in claim 1, wherein at least one of the fractions of the image frame consists of one pixel.

8. (canceled)

9. The device as claimed in claim 1, wherein the one or more processors are further programmed to perform at least one of scaling and geometry correction on the received the image frame fractions before output to a memoryless display.

10. The device as claimed in claim 1, wherein the one or more processors are further programmed to control addressing between the received image frame fractions and the output image frame fractions.

11. The device as claimed in claim 3, wherein the one or more processors are further configured to receive buffered overlay data from a memory configured to buffer the overlay data received from the third interface.

12. The device as claimed in claim 1, wherein the device is comprised in an integrated circuit.

13. A system, comprising:
a memoryless digital image capture device having a frame readout rate;
a memoryless display having a refresh rate equal to the frame readout rate; and
a device, comprising one or more processors programmed to:
receive an image frame one fraction at a time, the image frame having been captured with the memoryless digital image capture unit;
buffer each of the received fractions of the image frame; and
output each of the buffered fractions of the image frame to the memoryless display one at a time.

14. The system as claimed in claim 13, wherein the memoryless digital image capture unit comprises a memoryless rolling shutter camera.

15. The system as claimed in claim 13, wherein the one or more processors are further programmed to enhance the received fractions of the image frame.

16. The system as claimed in claim 13, wherein the one or more processors are further programmed to:
receive overlay data associated with at least one of the received fractions of the image frame; and
mix the received overlay data with its associated at least one received fraction of the image frame.

17. The system as claimed in claim 16, wherein the one or more processors are further programmed to perform the mixing of the received overlay data with its associated at least one received fraction of the image frame by alpha blending the received overlay data with its associated at least one received fraction of the image frame.

18. The system as claimed in claim 13, wherein at least one of the fractions of the image frame consists of one pixel.

19. The system as claimed in claim 13, wherein digital image capture device readout is synchronized with display refresh.

20. A method comprising:
receiving an image frame one fraction at a time;
buffering each of the received fractions of the image frame;
outputting each of the buffered fractions of the image frame to a memoryless display one at a time.

21. The method of claim 20, further comprising:
receiving overlay data associated with at least one of the buffered fractions of the image frame; and
mixing the received overlay data with its associated at least one of the buffered fractions of the image frame.
